(19) United States
(12) Patent Application Publication
(10) Pub. No.: US 2013/0002620 A1
(43) Pub. Date: Jan. 3, 2013

(54) LIQUID CRYSTAL DISPLAY AND OVERDRIVE METHOD THEREOF

(75) Inventors: Long-Jie DU, Chu-Nan (TW); Hui-Lang LEE, Chu-Nan (TW)

(73) Assignees: CHIMEI INNOLUX CORPORATION, Chu-Nan (TW); INNOCOM TECHNOLOGY (SHENZHEN) CO., LTD., Shenzhen City (CN)

(21) Appl. No.: 13/536,920

(22) Filed: Jun. 28, 2012

(30) Foreign Application Priority Data
Jun. 30, 2011 (TW) 100123012

(51) Int. Cl. G09G 3/36; G06F 3/038

(52) U.S. Cl. 345/204; 345/87

(57) ABSTRACT

A liquid crystal display (LCD) and an overdrive method of an LCD, which benefits multi-frame polarity inversion technology, are provided. A timing controller of an LCD receives a video and provides the following operations. In a case wherein a multi-frame polarity inversion manner is used, if a current frame that is processed to be displayed on the screen requires polarity inversion, the timing controller performs an overdrive procedure in accordance with a first overdrive rule, and, if the current frame does not require polarity inversion, the timing controller performs the overdrive procedure in accordance with a second overdrive rule different from the first overdrive rule.

### CROSS REFERENCE TO RELATED APPLICATIONS

This Application claims priority of Taiwan Patent Application No. 10012301.2, filed on Jun. 30, 2011, the entirety of which is incorporated by reference herein.

### BACKGROUND OF THE INVENTION

1. Field of the Invention

The present invention relates to liquid crystal displays, and in particular relates to overdrive technologies for multi-frame polarity inversion design.

2. Description of the Related Art

AC driving is commonly used in LCD panels. By continuously reversing the polarity of driving voltages of liquid crystal materials, the orientations of the liquid crystal materials are reversed over and over, thereby extending the operational lifespan of liquid crystal materials. For example, frame inversion, row/gate/line inversion, column/data/source inversion, and dot inversion are conventional AC driving technologies.

Overdrive technology is also commonly used in LCD panels, to cope with the slow rotation of the liquid crystal materials. For example, a conventional overdrive technology may compare a current frame (that is processed to be displayed on the screen) with a previous frame. For each pixel, the gray level difference obtained from the current and the previous frame is applied for table look up to obtain an overdrive gray level. Instead of the original gray level, the overdrive gray level is used as image display. Thus, the liquid crystal materials are rotated to the correct orientations in time even if there is a considerable change between the contiguous frames.

However, conventional AC driving and overdrive technologies are unsuitable for application in shutter 3D displays (wherein the left eye images and right eye images are displayed in turns).

FIG. 1 depicts one pixel in contiguous frames, showing the polarity changes of the pixel when a conventional AC driving technology is used. As shown, for the pixel driven in accordance with the conventional AC driving technology, change in polarity occurs for every frame. When displaying a shutter 3D video, the pixel polarity is always positive for left eye images and is always negative for right eye images. Viewers may see unbalanced right and left eye images due to display differences between the positive polarity driving and the negative polarity driving.

Therefore, the AC driving technology has to be modified for shutter 3D display and, with the improved AC driving technology, a novel overdrive technology is called for.

### BRIEF SUMMARY OF THE INVENTION

A liquid crystal display (LCD) and an overdrive technology for an LCD are disclosed, which perform well when displaying images in a multi-frame polarity inversion manner and is suitable for shutter 3D displays or other image displays in the multi-frame polarity inversion manner.

A liquid crystal display in accordance with an exemplary embodiment of the invention comprises a liquid crystal panel, a scan driver, a data driver and a timing controller. The scan driver and the data driver output scan line signals and data line signals to the liquid crystal panel. The timing controller controls the scan driver and the data driver.

The timing controller is operative to receive a video and operates as detailed below. When a multi-frame polarity inversion manner is used, the timing controller performs an overdrive procedure in accordance with a first overdrive rule if a current frame requires polarity inversion, and performs the overdrive procedure in accordance with a second overdrive rule different from the first overdrive rule if no polarity inversion is required for the current frame. In the multi-frame polarity inversion manner, polarity changes occur every N frames, where N is an integer equal to or greater than 2.

By an LCD overdrive method in accordance with an exemplary embodiment of the invention, a video may be received and the method may comprise the following steps. First, it is determined whether a multi-frame polarity inversion manner designed for shutter 3D display is used. When the multi-frame polarity inversion manner is not used, an overdrive procedure is performed in accordance with a first overdrive rule. When the multi-frame polarity inversion manner is used and no polarity inversion is required for a current frame, the overdrive procedure is performed in accordance with a second overdrive rule different from the first overdrive rule. When the multi-frame polarity inversion manner is used and the current frame requires polarity inversion, the overdrive procedure is performed in accordance with the first overdrive rule.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 depicts one pixel in contiguous frames, showing the polarity changes of the pixel when a conventional AC driving technology is used;

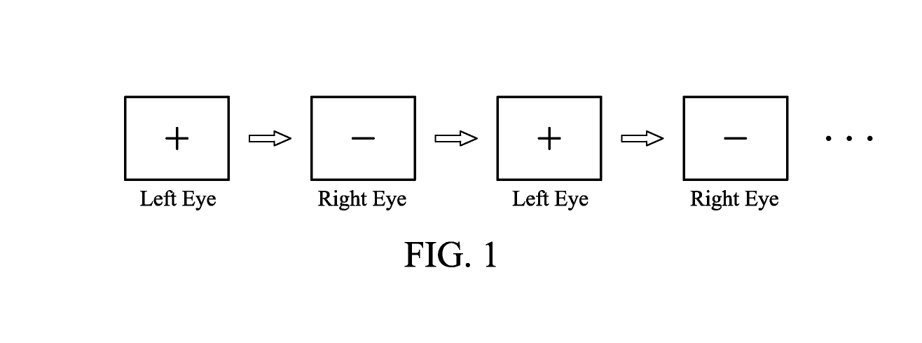

FIG. 2 depicts a liquid crystal display 200 in accordance with an exemplary embodiment of the invention;

FIG. 3 depicts an exemplary embodiment of the timing controller 208;

FIG. 4 shows one pixel in contiguous frames of a shutter 3D display, wherein the disclosed multi-frame polarity inversion manner and flexible overdrive technology are applied thereto; and

FIG. 5 is a flowchart depicting an LCD overdrive method in accordance with an exemplary embodiment of the invention.

### DETAILED DESCRIPTION OF THE INVENTION

The following description shows exemplary embodiments carrying out the invention. This description is made for the purpose of illustrating the general principles of the invention and should not be taken in a limiting sense. The scope of the invention is best determined by reference to the appended claims.

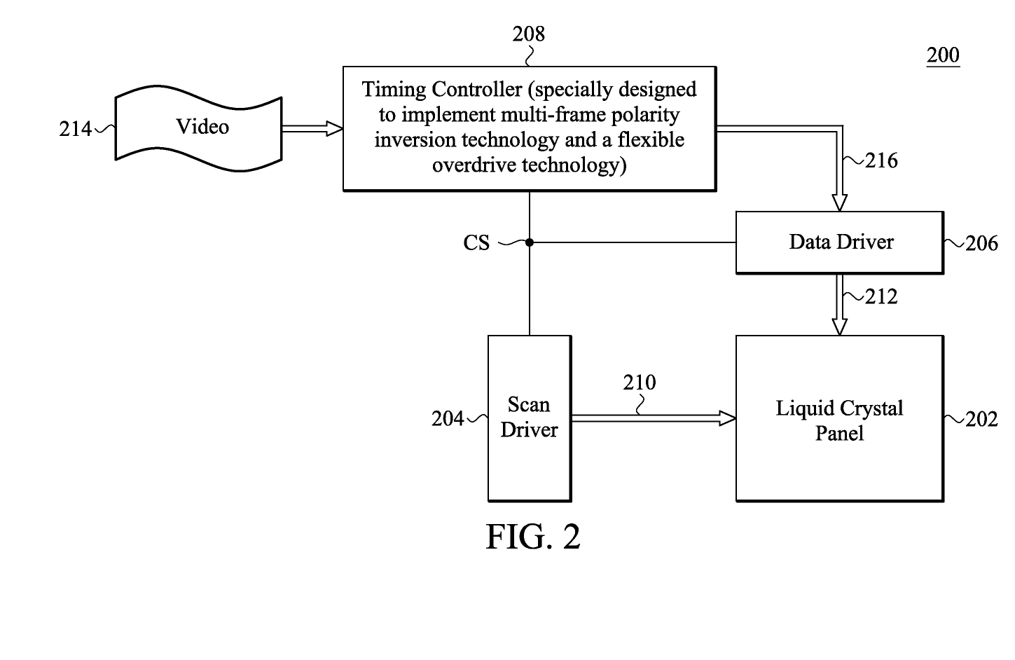

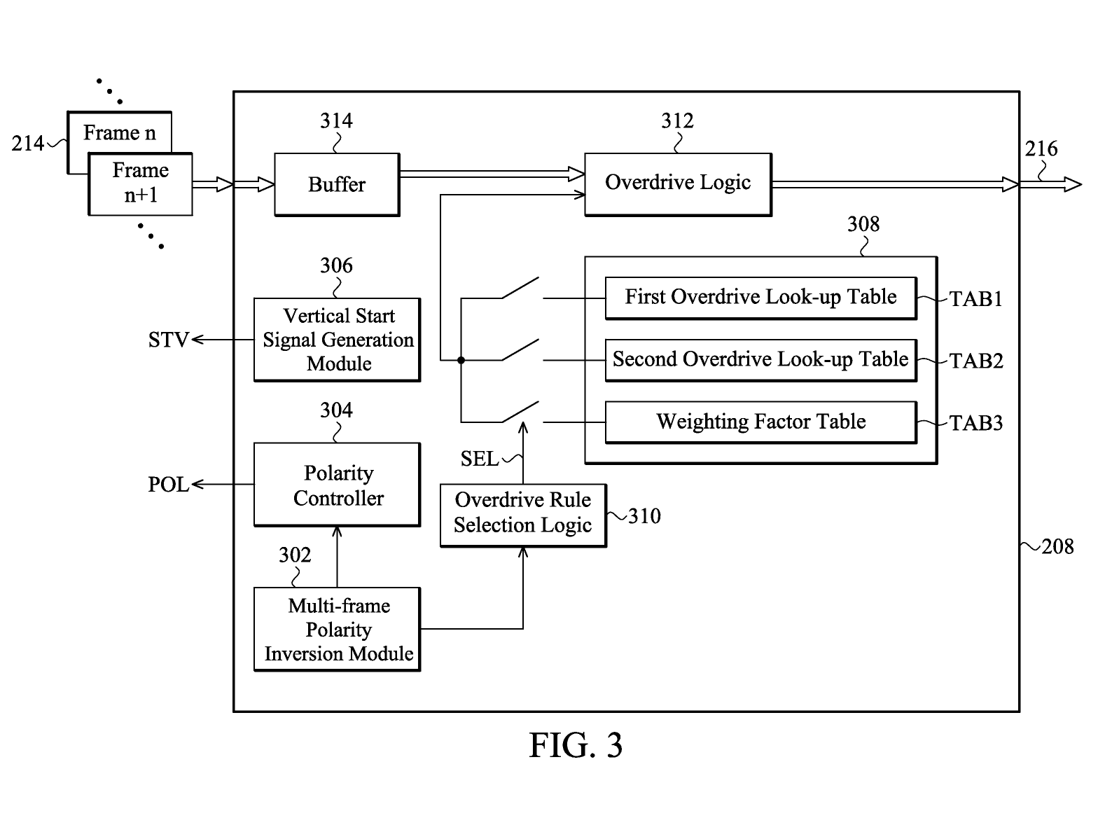

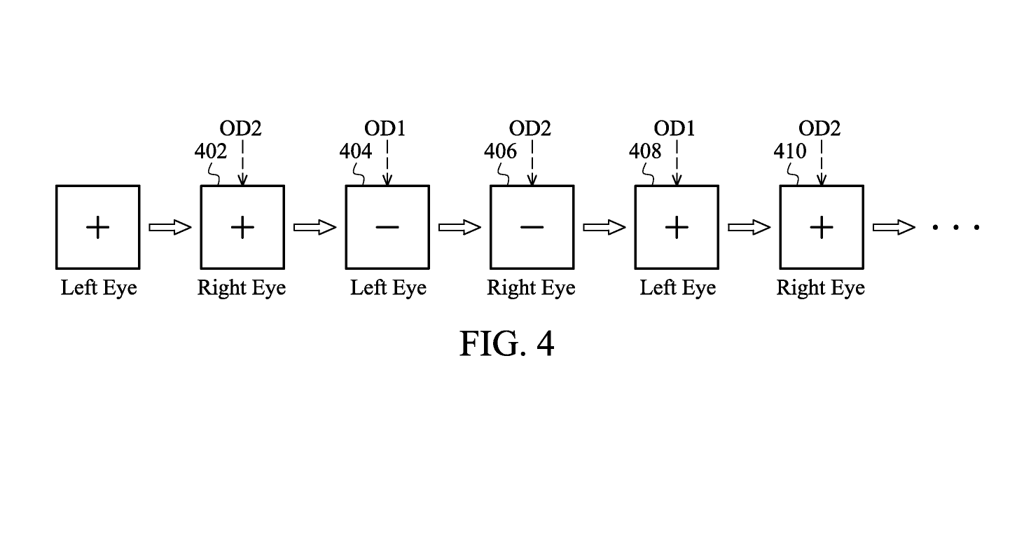

FIG. 2 depicts a liquid crystal display 200 in accordance with an exemplary embodiment of the invention. The liquid crystal display 200 comprises a liquid crystal panel 202, a scan driver 204, a data driver 206 and a timing controller 208. The scan driver 204 and the data driver 206 output scan line signals 210 and data line signals 212 to the liquid crystal panel 202. The timing controller 208 controls the scan driver 204 and the data driver 206, and receives a video 214. For perfect shutter 3D display, the timing controller 208 is specially designed to implement multi-frame polarity inversion technology and a flexible overdrive technology. The timing controller 208 outputs control signals CS to the scan driver 204 and the data driver 206 as well as outputs a video 216 that is overdrive corrected to the data driver 206. FIG. 3 depicts an exemplary embodiment of the timing controller 208. FIG. 4 shows one pixel in contiguous frames of a shutter 3D display, wherein the disclosed multi-frame polarity inversion technology and flexible overdrive technology are applied thereto.

As shown in FIG. 4, for the multi-frame polarity inversion technology, the polarity of the pixel is not switched every frame. Instead, several frames correspond to one polarity change. In the example of FIG. 4, a 2-frame polarity inversion technology is shown, the polarity of the pixel is changed every two frames. In this manner, when displaying a shutter 3D video in which left and right eye images are displayed alternatively, the pixel is no longer limited to display the left eye image data by the positive polarity and to display the right eye image data by the negative polarity. Viewers can enjoy balanced left eye and right eye images. Note that the disclosed multi-frame polarity inversion technology is not limited to 2-frame inversion technology. In other embodiments, the polarity changes may occur for every 3, or 4 or more frames. In the field of polarity inversion driving, once the pixel polarity is maintained for at least two frames, it is regarded as the disclosed multi-frame polarity inversion technology.

In the disclosed multi-frame polarity inversion manner, a pixel only requires polarity inversion in some frames. For example, as shown in FIG. 4, polarity inversion is required in the display of 404 and 408 but is not required in the display of 402, 406 and 410. For conventional overdrive technologies, however, which are specially designed for the cases which require polarity inversion, they are not suitable for the cases in which no polarity inversion is required. To cope with this problem, the timing controller 208 of FIG. 2 uses flexible overdrive technology. Referring to FIG. 4, for flexible overdrive technology, a first overdrive rule OD1 is applied to the display of 404 and 408 in which polarity inversion is required, and a second overdrive rule OD2 different from the first overdrive rule OD1 is applied to the display of 402, 406 and 410 in which no polarity inversion occurs. In an exemplary embodiment, the first overdrive rule OD1 is stronger than the second overdrive rule OD2. For identical gray level changes, the overdrive operation in accordance with the first overdrive rule OD1 is more significant than that in accordance with the second overdrive rule OD2.

This paragraph gives an example, in which the overdrive operation in accordance with the first overdrive rule OD1 is more significant than that in accordance with the second overdrive rule OD2. In this case, one pixel is changed from gray level n1 to gray level n2. In accordance with the first overdrive rule, an overdrive gray level n3 is obtained to actually drive the pixel. The driving voltage Vn3 corresponds to the overdrive gray level n3. In accordance with the second overdrive rule, an overdrive gray level n4 is obtained to actually drive the pixel. The driving voltage Vn4 corresponds to the overdrive gray level n4. If the gray level change of the pixel is from low to high (n1<n2), the overdrive gray level n3 generated in accordance with the first overdrive rule OD1 is greater than the overdrive gray level n4 generated in accordance with the second overdrive rule OD2, i.e. n3>n4. On the contrary, if the gray level change of the pixel is from high to low (n2<n1), n3<n4.

In this manner, a perfect video is shown because it does not matter whether polarity inversion occurs or not, the most suitable overdrive rule is implemented.

An exemplary embodiment of the disclosed timing controller is shown in detail in FIG. 3.

Referring to FIG. 3, the timing controller 208 may comprise a multi-frame polarity inversion module 302, so that the timing controller 208 can implement the aforementioned multi-frame polarity inversion technology.

Furthermore, the timing controller 208 may comprise a polarity controller 304 and a vertical start signal (STV) generation module 306. The polarity controller 304 outputs a polarity inversion signal POL to control the data driver 206 in accordance with operations of the multi-frame polarity inversion module 302. For example, when the multi-frame (N frames, N is greater or equal to 2) polarity inversion module 302 is disabled, the polarity controller 304 changes the value of the polarity inversion signal POL every frame. When the multi-frame polarity inversion module 302 is enabled, the polarity controller 304 changes the value of the polarity inversion signal POL every N frames. The vertical start signal generator 306 outputs a vertical start signal STV to control the scan driver 204. For example, the vertical start signal STV may be received by the first shift register of the scan driver. The pulse conveyed by the vertical start signal STV invokes the scan of the liquid crystal panel. In an exemplary embodiment, the timing controller 208 uses the polarity inversion signal POL and the vertical start signal STV to determine whether polarity inversion is required for a current frame that is processed to be displayed on the screen.

The timing controller 208 shown by FIG. 3 further comprises a memory unit 308, an overdrive rule selection logic 310, an overdrive logic 312 and a buffer 314. The memory unit 308 may store a first overdrive look-up table TAB1, a second overdrive look-up table TAB2 and a weighting factor table TAB3. The overdrive rule selection unit 310 outputs a selection pointer SEL pointing to the memory unit 308 to obtain data from the memory unit 308. According to the data indicated by the selection pointer SEL, the overdrive logic 312 performs an overdrive procedure. The buffer 314, buffering the video 214 received by the timing controller 208, outputs the buffered video to the overdrive logic 312 to be processed by the overdrive procedure.

Note that the memory unit 308 may only store the first overdrive look-up table TAB1 and the second overdrive look-up table TAB2 but not store the weighting factor table TAB3. The first overdrive look-up table TAB1 is used to build a first overdrive rule (e.g. OD1 shown in FIG. 4). The second overdrive look-up table TAB2 is used to build a second overdrive rule (e.g. OD2 shown in FIG. 4). When the multi-frame polarity inversion module 302 is enabled, the overdrive rule selection logic 310 may comprise the following operations: i) when a current frame that is processed to be displayed on the screen requires polarity inversion, the overdrive rule selection logic 310 may point the selection pointer SEL to the first overdrive look-up table TAB1 stored in the memory unit 308 to instruct the overdrive logic 312 to perform the overdrive procedure in accordance with the first overdrive rule OD1; and ii) when no polarity inversion is required for the current frame, the overdrive rule selection module 310 may point the selection pointer SEL to the second overdrive look-up table TAB2 stored in the memory unit 308 to instruct the overdrive logic 312 to perform the overdrive procedure in accordance with the second overdrive rule OD2. In a case wherein the multi-frame polarity inversion module 302 is disabled, the overdrive rule selection logic 310 may point the selection pointer SEL to the first overdrive look-up table TAB1 stored in the memory unit 308 to instruct the overdrive logic 312 to perform the overdrive procedure in accordance with the first overdrive rule OD1, which is the same as that adopted when the multi-frame polarity inversion module 302 is enabled and polarity inversion is required for the current frame that is processed to be displayed on the screen.

In another exemplary embodiment, the memory unit 308 may store the first overdrive look-up table TAB1 and the weighting factor table TAB3 without storing the second overdrive look-up table TAB2. The first overdrive look-up table TAB1 is designed to build a first overdrive rule (e.g. OD1 shown in FIG. 4). The weighting factor table TAB3 is used in adjusting the weightings of the data provided by the first overdrive look-up table TAB1 to build a second overdrive rule (e.g. OD2 shown in FIG. 4). When the multi-frame polarity inversion module 302 is enabled, the overdrive rule selection logic 310 may comprise the following operations: i) when a current frame that is processed to be displayed on the screen requires polarity inversion, the overdrive rule selection logic 310 may point the selection pointer SEL to the first overdrive look-up table TAB1 stored in the memory unit 308 to instruct the overdrive logic 312 to perform the overdrive procedure in accordance with the first overdrive rule OD1; and ii) when no polarity inversion is required for the current frame, the overdrive rule selection module 310 may point the selection pointer SEL to the first overdrive look-up table TAB1 and the weighting factor table TAB3 both to instruct the overdrive logic 312 to perform the overdrive procedure in accordance with the second overdrive rule OD2. In a case wherein the multi-frame polarity inversion module 302 is disabled, the overdrive rule selection logic 310 may point the selection pointer SEL to the first overdrive look-up table TAB1 stored in the memory unit 308 to instruct the overdrive logic 312 to perform the overdrive procedure in accordance with the first overdrive rule OD1, which is the same as that adopted when the multi-frame polarity inversion module 302 is enabled and polarity inversion is required for the current frame that is processed to be displayed on the screen.

Note that the size of the weighting factor table TAB3 may be much smaller than the first overdrive look-up table TAB1. For example, the weighting factor table TAB3 may simply contain a few number of weighting factors or even just one single weighting factor. However, it is enough to build a second overdrive rule OD2. The second overdrive rule OD2 may be established by adjusting the weightings of the data provided from the first overdrive look-up table TAB1 in accordance with the small-sized data contained in the weighting factor table TAB3. Compared to the case which refers to the first and second overdrive look-up tables TAB1 and TAB2 for performing the overdrive procedure, the cost of the memory unit 308 is considerably reduced in the case which simply refers to the first overdrive look-up table TAB1 and the weighting factor table TAB3.

In another exemplary embodiment, the memory unit 308 may contain the first overdrive look-up table TAB1, the second overdrive look-up table TAB2 and the weighting factor table TAB3. The first overdrive look-up table TAB1 is designed to build a first overdrive rule (e.g. OD1 of FIG. 4). The weighting factor table TAB3 is applied in adjusting the weightings of the data provided from the second overdrive look-up table TAB2. The weighted data may be biased by the data stored in the first overdrive look-up table TAB1 (TAB1+TAB3*TAB2), thus a second overdrive rule (e.g. OD2 of FIG. 4) is established. When the multi-frame polarity inversion module 302 is enabled, the overdrive rule selection logic 310 may comprise the following operations: i) when a current frame that is processed to be displayed on the screen requires polarity inversion, the overdrive rule selection logic 310 may point the selection pointer SEL to the first overdrive look-up table TAB1 stored in the memory unit 308 to instruct the overdrive logic 312 to perform the overdrive procedure in accordance with the first overdrive rule OD1; and ii) when no polarity inversion is required for the current frame, the overdrive rule selection module 310 may point the selection pointer SEL to the first and second overdrive look-up tables TAB1 and TAB2 and the weighting factor table TAB3 to instruct the overdrive logic 312 to perform the overdrive procedure in accordance with the second overdrive rule OD2. In a case wherein the multi-frame polarity inversion module 302 is disabled, the overdrive rule selection logic 310 may point the selection pointer SEL to the first overdrive look-up table TAB1 stored in the memory unit 308 to instruct the overdrive logic 312 to perform the overdrive procedure in accordance with the first overdrive rule OD1, which is the same as that adopted when the multi-frame polarity inversion module 302 is enabled and polarity inversion is required for the current frame that is processed to be displayed on the screen.

The function blocks within the timing controller shown in FIG. 3 may be integrated within one chip and manufactured as a timing control chip or, in other exemplary embodiments, the memory unit 308 is external to a timing control chip when considering manufacturing costs.

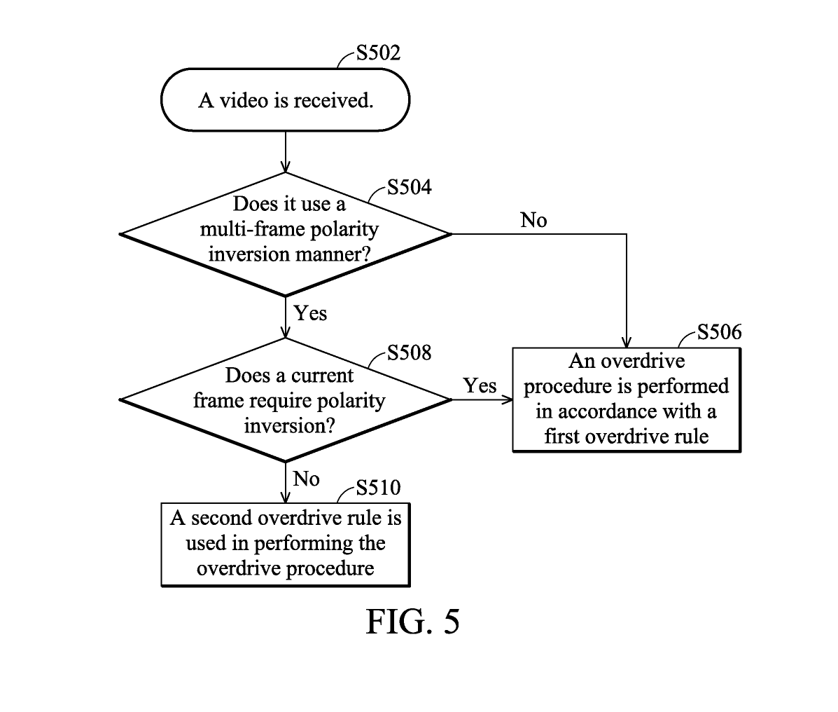

FIG. 5 is a flowchart depicting an LCD overdrive method in accordance with an exemplary embodiment of the invention. First, in step S502, a video is received. In step S504, it is determined whether a multi-frame polarity inversion manner is used. When the multi-frame polarity inversion manner is not used, step S506 is performed, and the overdrive procedure is performed in accordance with a first overdrive rule. When the multi-frame polarity inversion manner is used, step S508 is performed, wherein it is determined whether a current frame that is processed to be displayed on the screen requires polarity inversion. When the multi-frame polarity inversion manner is used and it is determined that no polarity inversion is required for the current frame, step S510 is performed, wherein a second overdrive rule (e.g. OD2 of FIG. 4) different from the first overdrive rule (e.g. OD1 of FIG. 4) is used in performing the overdrive procedure. On the contrary, when it is determined in step S508 that the current frame requires polarity inversion, step S506 is performed, wherein the first overdrive rule is applied to the overdrive procedure.

In an exemplary embodiment, the disclosed overdrive method may determine whether the current frame requires polarity inversion or not by referring to the status of a polarity inversion signal (generally labeled by ‘POL’) and a vertical start signal (generally labeled by ‘STV’) output from the timing controller of the controlled LCD.

In an exemplary embodiment, the disclosed overdrive method may further provide a memory unit (e.g. memory unit 308 of FIG. 3) storing a first overdrive look-up table (TAB1 of FIG. 3) and a second overdrive look-up table (TAB2 of FIG. 3) to build a first overdrive rule and a second overdrive rule, respectively. When the multi-frame polarity inversion manner is not used, the overdrive procedure may be performed by referring to the first overdrive look-up table stored in the memory unit. When the multi-frame polarity inversion manner is used and no polarity inversion is required for the current frame that is processed to be displayed on the screen, the overdrive procedure may be performed by referring to the second overdrive look-up table stored in the memory unit. In a case wherein the multi-frame polarity inversion manner is used and the current frame requires polarity inversion, the overdrive procedure may be performed by referring to the first overdrive look-up table stored in the memory unit.

In another exemplary embodiment, the memory unit used in the disclosed overdrive method may store a first overdrive look-up table (TAB1 of FIG. 3) and a weighting factor table (TAB3 of FIG. 3). The first overdrive look-up table is designed to build a first overdrive rule. The weighting factor table is designed to modify the weightings of the data provided from the first overdrive look-up table to build a second overdrive rule. When the multi-frame polarity inversion manner is not used, an overdrive procedure may be performed by referring to the first overdrive look-up table stored in the memory unit. When the multi-frame polarity inversion manner is used and no polarity inversion is required for a current frame that is processed to be displayed on the screen, the overdrive procedure may be performed by referring to the memory unit for the first overdrive look-up table and the weighting factor table both. When the multi-frame polarity inversion manner is used and the current frame requires polarity inversion, the overdrive procedure may be performed by referring to the first overdrive look-up table stored in the memory unit.

Note that the aforementioned panel driving techniques are not limited to a shutter 3D display. The disclosed overdrive technology is suitable to be used with any multi-frame polarity inversion technology that reverses the LC polarity every N frames, where N is an integer greater than or equal to 2.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A liquid crystal display, comprising:
a liquid crystal panel;
a scan driver and a data driver, providing the liquid crystal panel with a plurality of scan signals and a plurality of data signals; and
a timing controller operative to control the scan driver and the data driver, wherein the timing controller receives a video and, when a multi-frame polarity inversion manner is used, the timing controller performs an overdrive procedure in accordance with a first overdrive rule if a current frame that is processed requires polarity inversion, and performs the overdrive procedure in accordance with a second overdrive rule different from the first overdrive rule if the current frame does not require polarity inversion, wherein, in the multi-frame polarity inversion manner, the polarity of the liquid crystal materials of the liquid crystal panel is reversed every N frames where N is an integer greater or equal to 2.

2. The liquid crystal display as claimed in claim 1, wherein the first overdrive rule is stronger than the second overdrive rule, and, for identical gray level changes, an overdrive operation obtained from the first overdrive rule is more significant than that obtained from the second overdrive rule.

3. The liquid crystal display as claimed in claim 1, wherein the multi-frame polarity inversion manner is applied to a shutter 3D display.

4. The liquid crystal display as claimed in claim 1, wherein the timing controller further comprises:
a multi-frame polarity inversion module, to implement the multi-frame polarity inversion manner.

5. The liquid crystal display as claimed in claim 4, wherein the timing controller further comprises:
a polarity controller, outputting a polarity inversion signal in accordance with operations of the multi-frame polarity inversion module to control the data driver; and
a vertical start signal generation module, outputting a vertical start signal to control the scan driver.

6. The liquid crystal display as claimed in claim 5, wherein the timing controller determines whether the current frame requires polarity inversion in accordance with the polarity inversion signal and the vertical start signal.

7. The liquid crystal display as claimed in claim 4, wherein the timing controller further comprises:
a memory unit, storing a first overdrive look-up table and a second overdrive look-up table for building the first and the second overdrive rules, respectively;
an overdrive rule selection logic, outputting a selection pointer, wherein, when the multi-frame polarity inversion module is enabled and the current frame requires polarity inversion, the overdrive rule selection logic points the selection pointer to the first overdrive look-up table stored in the memory unit, and, when the multi-frame polarity inversion module is enabled and no polarity inversion is required for the current frame, the overdrive rule selection logic points the selection pointer to the second overdrive look-up table stored in the memory unit;
an overdrive logic, performing the overdrive procedure according to data indicated by the selection pointer; and
a buffer, buffering the video received by the timing controller, wherein the buffed video is transferred to the overdrive logic to be processed by the overdrive procedure.

8. The liquid crystal display as claimed in claim 7, wherein the overdrive rule selection logic further points the selection pointer to the first overdrive look-up table stored in the memory unit when the multi-frame polarity inversion module is disabled.

9. The liquid crystal display as claimed in claim 4, wherein the timing controller further comprises:
a memory unit, storing a first overdrive look-up table and a weighting factor table, wherein the first overdrive look-up table builds the first overdrive rule and the weighting factor table adjusts weightings of data provided from the first overdrive look-up table to build the second overdrive rule;
an overdrive rule selection logic, outputting a selection pointer, wherein, when the multi-frame polarity inversion module is enabled and the current frame requires polarity inversion, the overdrive rule selection logic points the selection pointer to the first overdrive look-up table stored in the memory unit, and, when the multi-frame polarity inversion module is enabled and no polarity inversion is required for the current frame, the overdrive rule selection logic points the selection pointer to the first overdrive look-up table and the weighting factor table both;
an overdrive logic, performing the overdrive procedure according to data indicated by the selection pointer; and
a buffer, buffering the video received by the timing controller, wherein the buffered video is transferred to the overdrive logic to be processed by the overdrive procedure.

10. The liquid crystal display as claimed in claim 9, wherein the overdrive rule selection logic further points the selection pointer to the first overdrive look-up table stored in the memory unit when the multi-frame polarity inversion module is disabled.

11. An overdrive method for a liquid crystal display, comprising:
receiving a video;
determining whether a multi-frame polarity inversion manner is used, wherein the multi-frame polarity inversion manner reverses polarity of liquid crystal materials of the liquid crystal display every N frames, where N is an integer greater or equal to 2;
performing an overdrive procedure in accordance with a first overdrive rule when it is determined that the multi-frame polarity inversion manner is not used;
determining whether polarity inversion is required for a current frame that is processed when it is determined that the multi-frame polarity inversion manner is used;
performing the overdrive procedure in accordance with a second overdrive rule different from the first overdrive rule when it is determined that the multi-frame polarity inversion manner is used and polarity inversion is not required for the current frame; and
performing the overdrive procedure in accordance with the first overdrive rule when it is determined that the multi-frame polarity inversion manner is used and polarity inversion is required for the current frame.

12. The overdrive method as claimed in claim 11, wherein the first overdrive rule is stronger than the second overdrive rule that for identical gray level changes an overdrive operation provided in accordance with the first overdrive rule is more significant than that provided in accordance with the second overdrive rule.

13. The overdrive method as claimed in claim 10, further comprising:
determining whether the current frame requires polarity inversion in accordance with a polarity inversion signal and a vertical start signal which are output from a timing controller of the liquid crystal display,
wherein the polarity inversion signal is further used to control a data driver of the liquid crystal display, and the start pulse vertical signal is further used to control a scan driver of the liquid crystal display.

14. The overdrive method as claimed in claim 10, further comprising:
providing a memory unit to store a first overdrive look-up table and a second overdrive look-up table, wherein the first overdrive look-up table is used to build the first overdrive rule and the second overdrive look-up table is used to build the second overdrive rule;
performing the overdrive procedure by referring to the first overdrive look-up table stored in the memory unit when the multi-frame polarity inversion manner is not used;
performing the overdrive procedure by referring to the second overdrive look-up table stored in the memory unit when the multi-frame polarity inversion manner is used and no polarity inversion is required for the current frame; and
performing the overdrive procedure by referring to the first overdrive look-up table stored in the memory unit when the multi-frame polarity inversion manner is used and the current frame requires polarity inversion.

15. The overdrive method as claimed in claim 10, further comprising:
providing a memory unit storing a first overdrive look-up table and a weighting factor table, wherein the first overdrive look-up table is used to build a first overdrive rule, and the weighting factor table is used to modify the weighting of data provided from the first overdrive look-up table to build the second overdrive rule;
performing the overdrive procedure by referring to the first overdrive look-up table stored in the memory unit when the multi-frame polarity inversion manner is not used;
performing the overdrive procedure by referring to the memory unit for the first overdrive look-up table and the weighting factor table both when the multi-frame polarity inversion manner is used and no polarity inversion is required for the current frame; and
performing the overdrive procedure by referring to the first overdrive look-up table of the memory unit when the multi-frame polarity inversion manner is used and the current frame requires polarity inversion.
